(19) United States
(12) Patent Application Publication
(10) Pub. No.: US 2007/0272428 A1
(43) Pub. Date: Nov. 29, 2007

(54) Electric Field Control Material

(76) Inventors: Lorrene Bayon, Lyon (FR); Christian Koelblin, Meximieux (FR)

Correspondence Address: SOFER & HAROUN LLP., 317 MADISON AVENUE, SUITE 910, NEW YORK, NY, 10017, US

(21) Appl. No.: 10/591,622

(22) PCT Filed: Mar. 9, 2005
(86) PCT No.: PCT/FR05/50153

§ 371 Date: Jul. 5, 2007

(30) Foreign Application Priority Data
Mar. 9, 2004 (FR) 0450473

(51) Int. Cl. H02G 15/068

(52) U.S. Cl. 174/73.1

(57) ABSTRACT

The invention relates to an electric field control material comprising a polymer matrix with a nonlinear charge dispersed therein, said charge having nonlinear electric resistance properties. The invention is characterised in that the nonlinear charge comprises at least 97 wt.-% zinc oxide in the form of homogenous powder and less than 3 wt-% of at least one metallic oxide as trace elements.

The present invention relates to a material with non-linear electrical resistance, which is notably capable of controlling an electric field.

The invention finds a particular advantageous but non-exclusive application in the field of accessories for electrical cables, such as terminating elements or connecting elements.

A medium or high voltage power cable essentially consists of a conducting core which extends inside an insulating cladding covered with an armour forming a shield. Moreover, two semiconducting layers intended to smoothen the electric field extend between the conducting core and the insulating cladding on the one hand and between said insulating cladding and external armour on the other hand, respectively.

Now, when such an electric cable needs to be electrically connected to a termination element or any connecting element, its end needs to be partially stripped. After removing the shield and the directly adjacent semiconducting layer, the insulating cladding is then exposed to the distal portion of the electric cable. This has the effect of generating a very heterogeneous distribution of the electric field lines, and therefore an intense concentration of the electric field at the end of the directly adjacent semiconducting layer. This field concentration may in turn disadvantageously generate significant degradation of the insulator near the field concentration area, with as ultimate consequence, a high risk of electric breakdown.

To remedy this problem, it is known how to clad the end of the electric cable over a certain length, by means of non-linear electric resistance material. Because it has a variable dielectric constant, this type of material is actually capable of distributing the field lines more uniformly and of thus avoiding any concentration problem. With this, it is advantageously possible to distribute the potential at the ends of the electric cables and thereby prevent the risks of breakdown and of bypass.

Among the materials with non-linear electric resistances from the state of the art, composites may notably be distinguished which are essentially made up of a polymer matrix, in which a non-linear filler based on doped zinc oxide is dispersed.

In concrete terms, zinc oxide does not consist of a simple powder. It appears as a microstructure consisting of elementary grains partially integral with an inter-granular phase in which doping elements are concentrated, in this case metal oxides.

Indeed, although zinc oxide intrinsically has a non-linear current/voltage behavior, it has proved to be up to now indispensable to treat it in order to make its non-linearity compatible with an application of the field control type, in other words in order to ensure that its conductivity is sufficient. Now, it was demonstrated that with provision of doping elements, formation of grain boundaries and concentration of said dopants at said grain boundaries, this compatibility may be obtained specifically.

This type of composite materials however has the drawback of being costly to manufacture, because of the very high cost price of their non-linear fillers. Preparation of zinc oxide, prior to its integration into the polymer matrix, actually requires the application of conventional but expensive doping methods and of a high temperature heat treatment such as calcination and/or sintering. Creation of grain boundaries and migration of the dopants notably imposes a heat treatment of long duration, and this at high temperatures normally located around 1000° C.

Moreover, as the doping, calcination and/or sintering methods for the making of doped zinc oxides are very specific, only a few companies are able to master them. A risk of dependence of the user of these non-linear fillers, on a single supplier should therefore be feared. Of course, this is not a desirable situation from an economic point of view.

Another disadvantage of certain of these non-linear fillers relates to their toxicity, notably when they are doped with metal oxides based on cobalt, nickel or antimony for example. Moreover, this disadvantage is all the more significant since the filler and thus the dopants are generally present in a relatively large amount in the polymer matrix; said filler may account for up to 60% of the total volume of the material. In particular this characteristic proves to be a penalty during use as it forces the user to take very restricting safety measures all along the process for making the composite material.

It is also noted that if the composites obtained from doped, calcinated and/or sintered zinc oxide fillers in absolute terms are good materials with non-linear electric resistances, there remains nevertheless that their intrinsic dielectric rigidities may sometimes prove to be insufficient in practice.

Also the technical problem to be solved, by the object of the present invention, is to propose an electric field control material, including a polymer matrix in which a so-called non-linear filler is dispersed, having non-linear electric resistance properties, a material with which the problems of the state of the art may be avoided while being notably substantially less expensive and being produced less restrictively, while providing a significantly improved breakdown resistance.

The solution to the posed technical problem according to the present invention, consists in that the non-linear filler includes at least 97% by weight of zinc oxide as a homogeneous powder, and less than 3% by weight of at least a metal oxide as traces.

By a homogeneous powder is meant a structure which in majority consists of distinct grains, or even quasi-exclusively consisting of independent grains, and in which the grain boundaries are present in a very small minority, or even quasi-absent.

The notion of traces, as such, means that each metal oxide is present in an extremely minor amount, in a very low concentration. These foreign elements should moreover be considered as impurities, resulting from natural presence within the zinc oxide and/or from the application of the filler production method. Anyhow, the whole of the metal oxides considered as traces typically accounts for less than 5% by mass, and more generally less than 3% by mass.

Unlike its counterpart from the state of the art, zinc oxide is therefore not used here in a doped form, as moreover implicitly confirmed by the extremely reduced proportion of metal oxides in the filler, as well as the absence of a real intergranular phase in a powder of homogeneous structure. The present metal oxides in the invention are by no means doping elements.

The notion of non-linear filler should be understood in the broad sense of the term, i.e., it may designate both a single filler and a plurality of fillers, the nature and/or the composition of which are distinct, but the actions of which combine to impart the desired non-linearity to the composite material.

In addition to their non-linear electric properties, such fillers according to the invention, have properties defined in terms of direct current conductivity. It is known that a filler may be introduced into a polymer matrix beyond a maximum determined rate, which notably depends on the nature of said matrix and on the mixing process used. The non-linear behavior of the composite should therefore be obtained by incorporating the filler at a rate less than or equal to the maximum rate.

The filling rate from which a non-linear behavior may be observed, is called the percolation threshold. This threshold strongly depends on the properties of the matrix, but also on those of the filler. The properties of the matrix, which are capable of influencing the percolation threshold, inexhaustively are resistivity and the level of internal mechanical stresses. As regards the properties of the filler which are determining in this context, the morphology and the size of the particles as well as the intrinsic conductivity of said filler, may especially be mentioned but in a non-limiting way.

Thus, there exist minimum requirements in terms of conductivity, in order to be able to make the composites according to the invention by using filling rates less than the maximum rate. In a same matrix, with a more conductive filler, it is possible to obtain a non-linear composite with lower filling rates than by using a less conductive filler with the same morphology and the same particle size. By default, with a matrix exhibiting strong internal mechanical stresses, such as for example a thermosetting polymer, it is possible to obtain a non-linear composite with lower filling rates than by using the same filler in a less rigid matrix like elastomers.

Of course, many other types of fillers may be dispersed within the polymer matrix, depending on the particular properties which one finally desires to impart to the electric field control material.

The polymer matrix as such, may indifferently be of the thermoplastic, thermosetting, elastomer, liquid elastomer type, or consist in any mixture of polymers stemming from these different classes. Moreover it may contain one or more additives intended to enhance one or more of its final properties. All the additives of polymers known from the state of the art are relevant, such as for example antioxidant agents, UV stabilizing agents, coupling agents, dispersion agents, etc.

The invention as thereby defined, has the advantage of being able to have an extremely less expensive composite material than the electric field control materials of the state of the art. Indeed, by using zinc oxide without dopants, it is possible to get rid of the expensive doping, calcination and/or sintering methods of the prior art, which considerably lowers the price cost of such a non-linear filler, by at least a factor of ten, on average.

Moreover zinc oxide as a homogeneous powder is a quite standard product, which means that it is relatively available on the market of basic compounds. First of all, this gives the possibility of acquiring supplies from several suppliers in order to protect oneself from a possible risk of shortage, but also of being able to play the game of competition with the purpose of bringing down the prices as low as possible.

The very weak metal oxide content further makes the non-linear fillers of the invention substantially less restricting to handle, as compared with their counterparts from the state of the art, for which the metal oxide content is generally ten times greater on average.

Moreover, a composite material according to the invention generally provides a significantly larger dielectric rigidity than the electric field control materials of the prior art, and consequently a larger capability of withstanding electric breakdown. Moreover, this is all the more true since zinc oxide particles are used, which have in majority dimensions less than 10 μm.

Depending on the properties of the material making up the polymer matrix and possibly on those of the filler, a composite according to the invention may have a strong PTC (positive temperature coefficient of the electrical resistance), as well as a large capability of power dissipation, which advantageously allows it to be protected from any heat overload. With this marked PTC effect, the field of application of the composite materials, objects of the invention, may be widened.

Preferably, the non-linear filler includes less than 99.8% by weight of zinc oxide as a homogeneous powder. This means that the non-linear filler according to the invention contains at least 0.2% by mass of impurities essentially appearing as metal oxides.

In a particularly advantageous way, the grains making up the zinc oxide powder of the non-linear filler have dimensions in majority less than 50 μm, and preferably less than 10 μm.

According to another advantageous feature of the invention, each metal oxide is selected from lead oxide, cadmium oxide, iron(III) oxide, copper oxide and manganese oxide.

According to a particularity of the invention, the zinc oxide of the non-linear filler is doped with at least one non-metal element. First of all it should be noted that unlike the case of non-linear fillers based on doped zinc oxide from the state of the art, the doping which is relevant here does not lead to obtaining a microstructure characterized by the presence of elementary grains partially integral with an intergranular phase. It is then observed here that these are by no means dopants of the metal oxide type but dopants based on at least one non-metal element.

Each non-metal element, used as dopant of the non-linear filler, is preferably sulphur or boron. It may appear indifferently as an element or as a more or less complex compound.

According to another particularity of the invention, the field control material includes a so-called linear filler which has properties of linear electric resistance.

In an analogous way to the non-linear filler, the notion of linear filler should be understood in the broad sense of the term. It may thus designate both a single filler as well as a plurality of fillers of distinct nature and/or composition but the actions of which combine to impart a given conductivity to the composite material.

This means that it further incorporates at least one type of fillers which essentially consist of conducting or semi-conducting particles. A metal powder, such as iron powder, is an excellent example of linear filler capable of being incorporated into the composite material.

This feature gives large flexibility of use to the composite material according to the invention, since unlike the prior art, it is not necessary to have a specific non-linear filler for each concentrated application. Indeed, by incorporating a given linear filler in a determined amount, it is possible to adjust the conductivity of the composite material to make it compatible with the relevant application.

Preferably, the volume of the linear filler accounts for substantially less than 25% of the volume of the non-linear filler.

In a particularly advantageous way, the volume of non-linear filler and if necessary of linear filler accounts for substantially 5 to 60% of the volume of the field control material according to the invention, and preferably from 15 to 40% in volume.

According to another particularity of the invention, the field control material includes an insulating filler. There again, the notion of insulating filler relates both to a single filler and to a plurality of fillers, the nature and/or the composition of which are distinct, but the actions of which combine. Any insulating filler known from the state of the art may be used.

Preferably, the insulating filler accounts for less than 10% by volume of the field control material.

In an analogous way to the polymer matrix, each non-linear filler and/or each linear filler and/or each insulating filler may be treated with one or more additives capable of changing the final property(ies). For each filler considered separately, the treatment may optionally be performed on part or all of said filler. All the additives known from the state of the art may be used, and notably surface treatment agents.

The present invention also relates to the features which will become apparent during the description which follows, and which should be considered separately or according to all their possible technical combinations.

This description given as a non-limiting example will provide better understanding on how the invention may be achieved, with reference to the appended drawings wherein:

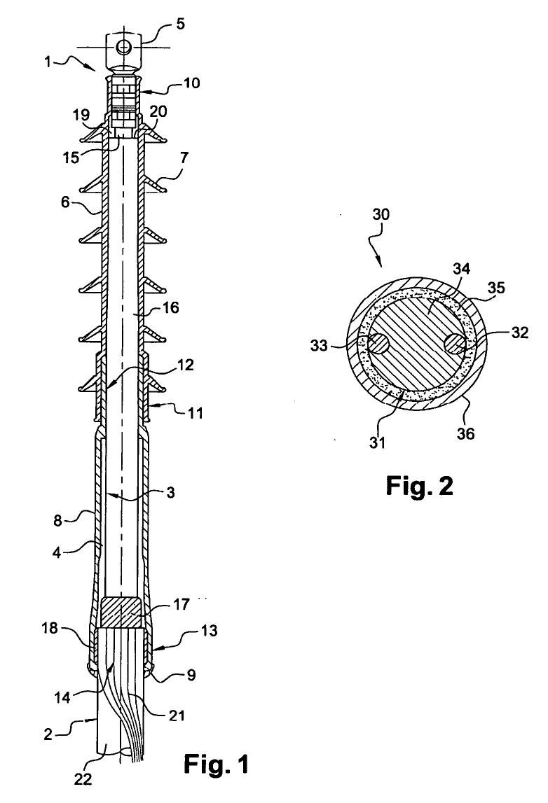

FIG. 1 is a longitudinal sectional view of an electric termination which is connected to the end of a power cable, and which includes a voltage distributor element consisting of a composite material according to the invention.

FIG. 2 illustrates in a cross-sectional view a self-regulating heating cable which includes as a PTC effect heating member, an element based on a material according to the invention.

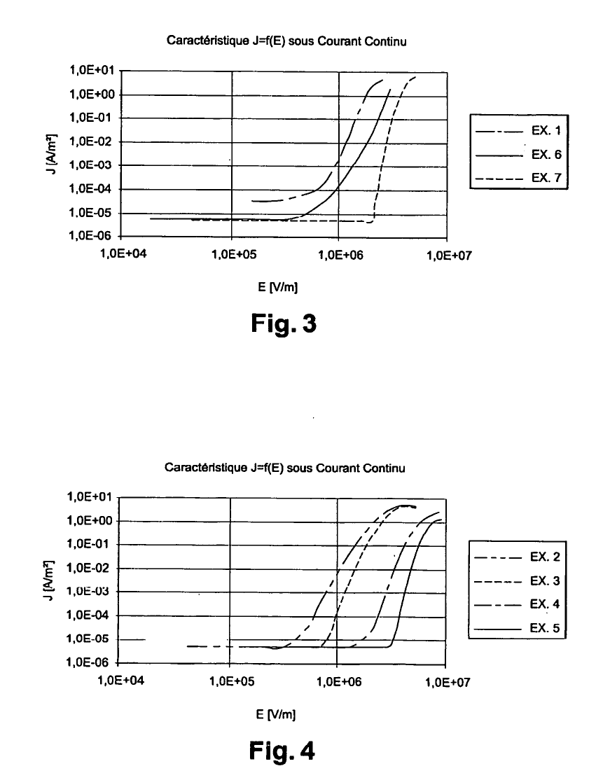

FIG. 3 illustrates a graph of the current density versus electric field type, which notably shows the influence of the nature of the zinc oxide powder and of the nature of the polymer matrix on the non-linearity of a field control material.

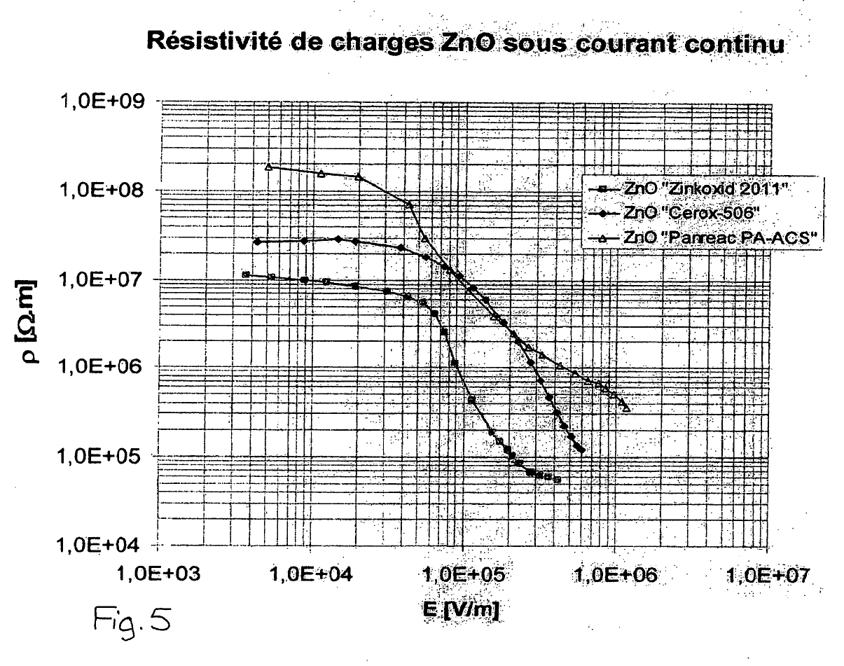

FIG. 4 shows a graph analogous to that of FIG. 3, which more particularly brings to light the influence of the filling rates on the electrical properties of a composite material according to the invention.

FIG. 5 is a graph which as such shows the relationship between the properties of a filler in terms of direct current conductivity, and the use of said filler in a composite material according to the invention.

For the sake of clarity, the same elements are designated with identical references. Also, only the elements essential for understanding the invention are illustrated, and this without observing the scale and schematically.

FIG. 1 illustrates a first application in which an electric termination 1 which is coupled to a power cable 2 includes an electric field distributor element 3 which appears here as a cladding 4 made in a composite material according to the invention.

The termination 1 consists of a connection pad 5, a first silicone rubber tube 6 provided with flanges 7, a second silicone rubber tube 8, an EPDM ring 9 and the cladding 4 in an electric field control material.

In concrete terms, the connection pad 5 is positioned at the distal end 10 of the first silicone rubber tube 6, the proximal portion of which 11 is itself fitted in around the distal part 12 of the second silicone rubber tube 8, the proximal part 13 of the second tube 8, as for it, will cover the unstripped end 14 of the power cable 2.

The power cable 2 as for it, conventionally consists of a conducting core 15 extending inside an insulating cladding 16. The latter is covered with an armour which is made up of a set of conducting wires 21 and of an external insulating cladding 22. Moreover, two semiconducting layers intended to smoothen the electric field extending between the conducting core 15 and the insulating cladding 16 on the one hand, and between said insulating cladding 15 and the external armour on the other hand, respectively. The outmost semiconducting layer, i.e., the one visible in FIG. 1, is designated by reference 17.

As the distal part of the power cable 2 is partially exposed, it is perfectly observed that the insulating cladding 16 extends both inside the second silicone rubber tube 8 and inside the first silicone rubber tube 6.

The termination 1 is made integral with the power cable 2 by means on the one hand of a first sealant 18 which forms an interface between the proximal part 13 of the second silicone rubber tube 8 and the unstripped end 14 of the power cable 2, and on the other hand by means of a second sealant 19 extending between the distal 20 of the insulating cladding 16 and the connecting pad 5.

The cladding 4 in a composite material according to the invention, which forms the electric field distributor element 3 of the termination 1, is placed inside the second silicone rubber tube 8. More specifically, the whole is laid out in such a way that the cladding 4 substantially extends in the continuity of the unstripped end 14, and covers the accessible end of the semi-conducting layer 17. Its shape, its dimensions and notably its length are adapted to the structural and functional characteristics of the power cable 2, according to practices of the state of the art.

According to a second application of the invention, a composite material according to the invention may equivalently be used in order to form an electric field distributor element in a connecting device for electric cables. Very generally, a connecting device means any member capable of providing either the electrical junction between at least two electric cables, or the connection of at least one electric cable to at least one electric or electronic device in the broad sense of the term.

The invention also applies to any power cable provided with at least one electric field distributor element consisting of a field control material as described earlier. Above all, here, one imagines electric cables for medium and/or high voltage.

Moreover, in the same way, the invention relates to any self-regulating heating cable provided with at least one PTC effect heating member, consisting of a composite material as described earlier.

In this respect, for information, FIG. 2 shows the structure of such an electric cable. In this particular exemplary embodiment, the self-regulating heating cable 30 includes a core 31 which consists of two conducting elements 32, 33 extending longitudinally in a central element 34 in extruded polymer. The whole is surrounded by a layer 35 which may be made in a non-linear electric resistance material according to the invention, and which exhibits a strong PTC effect. The whole is enveloped with an insulating external cladding 36.

According to a third application, a composite material which is in accordance with the invention, and which moreover has a strong PTC effect, may also be used in a particularly advantageous way in a device for limiting current with a PTC effect, notably in the field of thermistors and resettable fuses.

In any case, each electric field distributor element may assume a shape and/or any dimensions from the moment that they are adapted to the contemplated application.

Other characteristics and advantages of the present invention will become apparent in the light of the description of examples will follow; said examples being given as an illustration and being by no means limiting.

Examples 1-7 relate to compositions which are intended to form field control materials. Sample 1 more particularly corresponds to a composite material from the state of the art, whereas samples 2-7 on the contrary relate to composite materials according to the invention.

Table 1 details the proportions of the various constituents composing these materials, as well as their main electric properties, i.e., the threshold field and the non-linearity coefficient.

TABLE 1

| | Composition | Threshold | Non-linearity |
|---|---|---|---|
| Samp. | [% by volume] | field [kV/mm] | coefficient |
| 1 | 37.5 LSR 2540 CA | 0.7 | 10.6 |
| | 37.5 LSR 2540 CB | | |
| | 25.0 ZnO “PCF 78839” | | |
| 2 | 37.5 LSR 2540 CA | 0.4 | 7.8 |
| | 37.5 LSR 2540 CB | | |
| | 25.0 “ZnO KB” | | |
| 3 | 38.75 LSR 2540 CA | 0.8 | 9.8 |
| | 38.75 LSR 2540 CB | | |
| | 22.5 “ZnO KB” | | |
| 4 | 40.0 LSR 2540 CA | 2 | 11.4 |
| | 40.0 LSR 2540 CB | | |
| | 20.0 “ZnO KB” | | |
| 5 | 41.25 LSR 2540 CA | 3.2 | 13.5 |
| | 41.25 LSR 2540 CB | | |
| | 17.5 “ZnO KB” | | |
| 6 | 50.8 Ruetapox 0166/S20 | 0.4 | 5.4 |
| | 15.9 Ruetadur SG | | |
| | 33.3 ZnO “Cerox-506” | | |
| 7 | 37.5 LSR 2540 CA | 2 | 20.4 |
| | 37.5 LSR 2540 CB | | |
| | 25.0 ZnO “Zinkoxid 2011” | | |

The origin of the different constituents is the following:
Silopren® LSR 2540 is a trade mark registered by GE Bayer Silicones, which designates a two-component liquid silicone resin.
ZnO “PCF 78839” relates to a zinc oxide powder which is doped with metal dopants and which contains grain boundaries. This powder has notably been subject to a sintering step as well as a sieving operation intended to adjust the average diameter of the particles to about 25 μm. It is provided by Pharmacie Centrale de France SA.
“ZnO KB” corresponds to a trade mark registered by SILAR S.A.S, designating zinc oxide which is obtained by precipitation, i.e., by a wet method, and which contains a non-metal dopant, i.e., sulphur.
ZnO “Cerox-506” is a trade mark registered by Zinc Corporation of America, which relates to zinc oxide obtained by an indirect dry method, i.e., by a method commonly designated by the English term “French Process”.
Ruetapox® 0166/S20 is a trade mark registered by Bakelite AG, which corresponds to a modified epoxy resin based on bisphenol A and bisphenol F.
Ruetadur® SG is also a trade mark registered by Bakelite AG, but which relates to an amine based cross-linking agent.
ZnO “Zinkoxid 2011” is a trade mark registered by Grillo Zinkoxid GmbH, which designates zinc oxide obtained by a direct dry method, i.e., according to a method commonly designated by the English term “American Process”.

For making the different samples, all the methods known for making homogeneous mixtures between polymer matrix matrices and fillers with high specific weights may be used, for example by using an internal or dual screw mixer for thermoplastics, a blade mixer for epoxy resins.

Anyhow, in the present case, the following standard procedure was followed for making each field control material:
Drying the zinc oxide filler in an oven at 140° C. for 48 hrs.
Weighing suitable amounts of the resin and cross-linking agent components.
Mixing the resin and cross-linking agent components in a centrifugal mixer for 10 seconds at a rate of 2,350 revolutions per minute.
Weighing the required amount of zinc oxide filler, by adding it directly into the mixture of the resin and cross-linking agent component.
First homogenization in the centrifugal mixer for 20 seconds at a rate of 2,000 revolutions per minute.
Manual incorporation of possible filler residues which adhere to the walls and which are therefore not yet combined to the main mixture.
Final homogenization in the centrifugal mixer for 30 seconds at 2,000 revolutions per minute.
Picking up the required mixture amounts for molding round or rectangular plates, and spreading them on a flexible sheet in strengthened PTFE.
Degassing of the mixture for 15 minutes in a vacuum oven held at room temperature.
Molding and cross-linking of plates in a heating press held at a temperature of 150° C., with a pressure of 50 bars and for a period of 15 minutes.
After removal from the mold, the plates are annealed in an oven at 170° C. for 6 hrs.

It should be noted that for the samples which are based on liquid silicon rubber or LSR, and which are used for determining the mechanical properties, cross-linking in the heating press at 150° C. and under 50 bars is in fact carried out for a period of 10 minutes. As for the annealing in the oven, it takes place at 160° C. for 4 hrs.

This time regarding the sample based on epoxy resin, the mixture is prepared as described in the standard procedure, with the difference that the molding takes place in a specific mold in three pieces. The reactive mixture is first of all introduced into the cavity between two round aluminum electrodes with a diameter of 65 mm. The central portion is cylindrical and holds the electrodes at a set distance of 1.5 mm. The mold is closed under a hand press, the excess resin may be discharged through holes provided in the central portion of the mold. Cross-linking then occurs in an oven at 80° C. for 1 hr. The sample is then taken out of the mold and then annealed at a temperature of 140° C. for 4 hrs.

FIGS. 3 and 4 illustrate the behavior of samples 2-7 which are in accordance with the invention, as compared with sample 1 which is actually typical of the state of the art.

On the graphs illustrating the current density versus the electric field, it is first observed that all the constituent materials of samples 1-7 are perfectly compatible with an application of the field control material type. Their respective behaviors are actually all non-linear, and their respective conductivities prove to be all sufficient for this type of application, i.e., at any moment larger than a given threshold value.

The bias of the state of the art, according to which doping the zinc oxide filler as well as the presence of an inter-granular phase would be indispensable for giving the material a non-linear behavior compatible with an application of field control type, is therefore truly overcome. The natural presence of metal oxide as traces, moreover homogenously scattered in a powder of finer structure and not concentrated at the grain boundaries, proves to be perfectly sufficient for giving the composite material suitable conductivity for its function in the relevant application.

Next, the influence of the nature of the filler on the electric properties of the material is noted, by more particularly comparing the samples 1, 2 and 7 which all have the same polymer matrix (FIGS. 3 and 4). It is seen that it is possible to vary the threshold field, as well as the non-linearity coefficient, merely by changing the zinc oxide powder, i.e., without challenging the proportions of the different constituents of the material and/or without having to change the composition thereof.

A higher threshold field means that the composite may be used at substantially larger voltages of use. A higher non-linearity coefficient as such allows the material to react faster to field changes, therefore to adapt more rapidly.

By taking into account samples 2-5 (FIG. 4), it is further noted that the filling rate has an influence on the non-linearity of the field control material. By varying the proportion of zinc oxide, it is also thereby possible to change the values of the threshold field and of the non-linearity coefficient, i.e., the most significant non-linear characteristics in our context. This particularity means that advantageously it is not necessary to chemically change the zinc oxide powder in order to adapt the electric properties of the composite material.

This time referring to sample 6 (FIG. 3), it is observed that the nature of the polymer matrix also influences the non-linear behavior of the field control material. But this example essentially has the purpose of showing that a non-linear composite may be designed by using a zinc oxide filler, in this case of the “Cerox-506” type, for which the conductivity level is lower than those of the different fillers used for making the other exemplary samples.

In order to obtain a non-linear behavior comparable with that of the other tested composite materials, the filler “Cerox-506” is however advantageously associated with an epoxy matrix here. This type of resin actually forms a much more rigid matrix than a liquid silicone rubber. The internal forces exerted on the zinc oxide particles by the matrix, are consequently higher. This promotes the percolation phenomenon, i.e., the formation through the insulated matrix of conducting paths passing through the different zinc oxide particles.

Thus, a contrario, by combining a zinc oxide filler of the “Cerox-506” type with a matrix of the liquid silicon resin type, it is not possible to obtain a material according to the invention which is functional, i.e., a composite having a non-linear behavior and a conductivity which are compatible with an application of the electric field control type.

It should be noted that the epoxy matrix used in the sample 6 is applied in an analogous way to what was described earlier, and that it has a glass transition temperature of 130° C. In this respect, it should be observed that most epoxy resins used in the medium and high voltage range have a glass transition temperature between 60° C. and 140° C.

Moreover it is noted that in FIGS. 3 and 4, the horizontal levels in the low portion of the different curves are merely explained by the detection limit of the measuring system used. Consequently, in no way does this mean that each relevant sample has such a behavior at this specific location on the curve.

FIG. 5 shows the relationship between the conductivity and the direct current electric field, of three zinc oxide fillers which are suitable for making composite materials according to the invention. Depending on the conductivity level of each of these powders, it is possible to evaluate their respective behaviors in a given type of polymer matrix. It should be noted that as a reference parameter, it was chosen here to take into account the direct current resistivity, which represents the reciprocal value of the direct current conductivity mentioned until now.

Before the measuring step, each powder is first homogenized and then submitted to drying at 140° C. for 48 hrs in an oven. After cooling down to room temperature in a drier, a suitable amount of each filler was placed in a conventional dielectric measuring cell which is impervious to humidity of the ambient air and which may operate with adjustable mechanical pressures. In the present case, a compression force of 20 kN was applied constantly during each measurement.

During the measuring step, each powder was submitted to variable electric voltages, and the corresponding current values were successively recorded after a stabilization time of 60 seconds. The values of the electric field and of the resistivity are obtained by a simple calculation which uses the thickness of the compressed powder layer and the surface of the electrodes.

In the graph of FIG. 5, the strongly non-linear behavior and the relatively low resistivity versus the electric field p=f(E), for the “Zinkoxid 2011” powder used for making sample 7, are seen. This powder may therefore be used as a non-linear filler even in polymer matrices having a rather limited maximum filling rate, as this is the case for many elastomers.

The “Cerox-506” powder, used for making sample 6, shows a strongly non-linear behavior and a higher resistivity p=f(E), than that of the “Zinkoxid 2011” powder. Accordingly, the “Cerox-506” powder may be used as a non-linear filler in polymer matrices with a high maximum filling rate like epoxy resins or polyurethanes.

The third tested zinc oxide powder is from Panreac Quimica S.A. which distributes it under the brand “Panreac PA-ACS”. This powder exhibits a non-linear behavior and a higher resistivity p=f(E), than that ∘ the “Cerox-506” powder, except for electric field values between 8×10⁴ V/m and 2×10⁵ V/m. Taking into account its high resistivity, the “Panreac PA-ACS” powder may only be used as a non-linear filler in polymer matrices allowing the introduction of a very large amount of fillers, such as low viscosity epoxy resins.

So now, and according to a particularly feature of the invention, the zinc oxide has a direct current resistivity which is less than 10⁹ Ω.m, and preferably less than 10⁸ Ω.m. It should be noted that this particularity holds regardless of the value of the electric field.

Table 2 groups the results of a certain number of measurements recorded on samples 1, 2 and 7, in order to evaluate the mechanical properties of the materials of which they are made up, and notably the electric rigidity, the hardness, the elongation, the tensile strength and the tear resistance.

TABLE 2

| | Sample | | |
|---|---|---|---|
| | 1 | 2 | 7 |
| Dielectric rigidity, AC | 1.8 | 7.0 | 5.0 |
| 50 Hz [kV/mm] | | | |
| Hardness (Shore A) | 60 | 71 | — |
| Elongation [%] | 350 | 245 | — |
| Tensile strength [MPa] | 3.05 | 3.67 | — |
| Tear resistance [N/mm] | 2.05 | 2.46 | — |

As compared with the reference formed by the sample 1 of the prior art, it is immediately noted that the dielectric rigidity of the materials according to the invention is found to be substantially enhanced to the benefit of a larger breakdown strength.

For the remainder, a certain similarity is observed between the measured values, which merely means that in a particularly advantageous way, the use of non-linear fillers according to the invention does not challenge the main mechanical properties of this type of materials.

Legendes des Dessins

| | |
|---|---|
| Caractéristique J = f(E) | Direct current J = f(E) |
| sous courant continu | characteristic |
| Résistivité de charges ZnO | Direct current resistivity |
| sous courant continu | of ZnO fillers |

1. An electric field control material including a polymer matrix in which is dispersed a so-called non-linear filler having non-linear electric resistance properties, wherein the non-linear filler includes at least 97% by weight of zinc oxide as a homogeneous powder, and less than 3% by weight of at least one metal oxide as traces.

2. The material according to claim 1, wherein the non-linear filler includes less than 99.8% by weight of the zinc oxide as a homogenous powder.

3. The material according to claim 1, wherein the grains composing the zinc oxide powder of the non-linear filler have dimensions in majority less than 50 μm.

4. The material according to claim 1, wherein each metal oxide is selected from the group consisting of lead oxide, cadmium oxide, iron(III) oxide, copper oxide and manganese oxide.

5. The material according to claim 1, wherein the zinc oxide of the non-linear filler is doped with at least one non-metal element.

6. The material according to claim 5, wherein each non-metal element is sulphur or boron.

7. The material according to claim 1, wherein it includes a so-called linear filler having linear electric resistance properties.

8. The material according to claim 7, wherein the volume of the linear filler accounts for less than 25% of the volume of the non-linear filler.

9. The material according to claim 1, wherein it includes an insulating filler.

10. The material according to claim 9, wherein the insulating filler accounts for less than 10% by volume of said material.

11. The material according to claim 1, wherein the non-linear or the combination of the non-linear and the linear filler volume substantially accounts for 5 to 60% of the volume of said material.

12. The material according to claim 1, wherein the zinc oxide has a direct current resistivity which is less than 10⁹ Ω.m.

13. A termination for an electric cable, wherein it includes at least one electric field distributor element, including a material according to claim 1.

14. A connecting device for electrical cables, wherein it includes at least one electric field distributor element including a material according to claim 1.

15. A current limiting device, wherein it includes at least one PTC effect element, including a material according to claim 1.

16. A power cable, wherein it includes at least one electric field distributor element including a material according to claim 1.

17. Self-regulating heating cable, wherein it includes at least one PTC effect heating element including a material according to claim 1.

18. The material according to claim 3, wherein the grains composing the zinc oxide powder of the non-linear filler have dimensions in majority less than 10 μm.

19. The material according to claim 11, wherein the non-linear or the combination of the non-linear and the linear filler volume substantially accounts for 15 to 40% of the volume of said material.

20. The material according to claim 12, wherein the zinc oxide has a direct current resistivity which is less than 10⁸ Ω.m.
